(19) United States
(12) Patent Application Publication
(10) Pub. No.: US 2015/0185883 A1
(43) Pub. Date: Jul. 2, 2015

(54) MULTI-POINT TOUCH FOR IDENTITY

(71) Applicant: Arvind S, Bangalore (IN)

(72) Inventor: Arvind S, Bangalore (IN)

(21) Appl. No.: 14/142,426

(22) Filed: Dec. 27, 2013

(51) Int. Cl. G06F 3/041

(52) U.S. Cl. CPC G06F 3/041; G06F 2203/04104

(57) ABSTRACT

Described herein is a system for multi-point touch for identification. The system can include multi-point touch sensor firmware that identifies multiple points of touch. The firmware can also identify a pattern based on the multiple points of touch. The firmware can also identify an input device to the system based on the pattern.

### TECHNICAL FIELD

The present techniques relate generally to using multi-point touch entry for identifying input devices for touch screen computing devices.

BACKGROUND ART

Touch is becoming a popular means of data entry in mobile computing devices such as, tablets, table tops, smartphones, and the like. In some devices, the firmware that tracks input, by stylus or other input device, uses an identifier for the input device. Unfortunately, low cost input devices, like a passive stylus, lack the capability of providing their unique identifier to a smartphone's firmware. An active stylus has the identification capability, but is more expensive both in cost, and the energy used for communication.

### BRIEF DESCRIPTION OF THE DRAWINGS

FIG. 1 is a block diagram of an example computing device for multi-point touch identification, in accordance with embodiments.

FIG. 2 is a process flow diagram of a method for multi-point touch identification, in accordance with embodiments.

FIGS. 3A-3B are block diagrams of example input devices for multi-point touch identification, in accordance with embodiments.

FIG. 4 is a block diagram of an example input device for multi-point touch identification, in accordance with embodiments.

FIG. 5 is a block diagram depicting an example of a tangible, non-transitory computer-readable medium for multi-point touch identification, in accordance with embodiments.

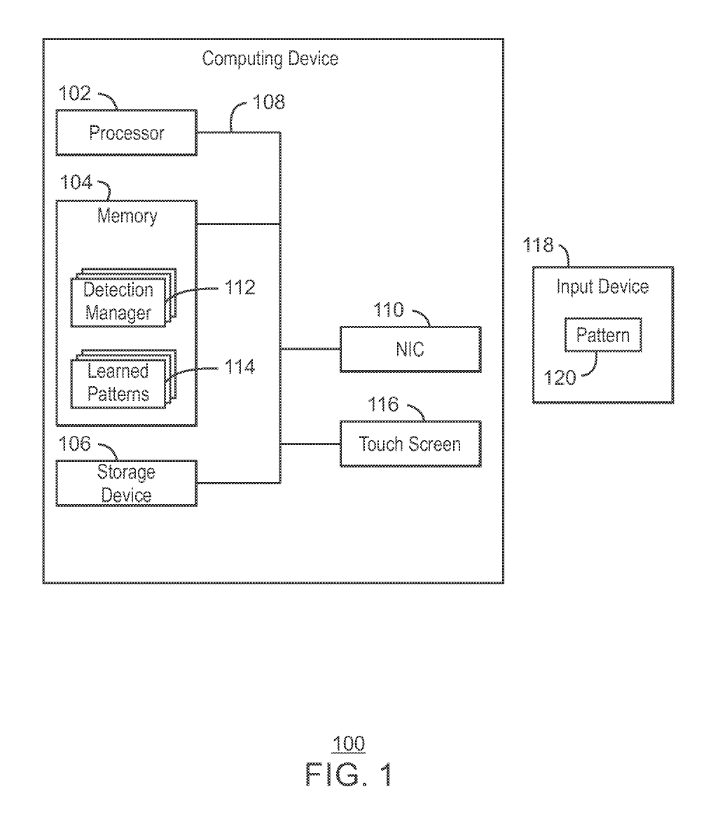

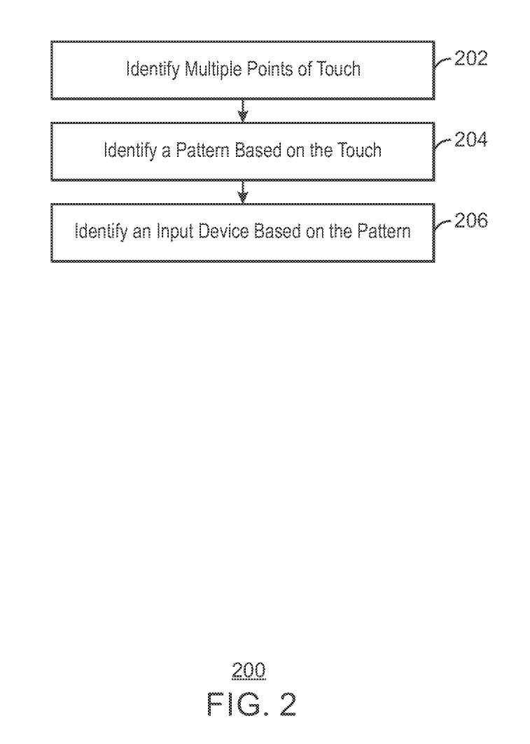

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Some embodiments may be implemented in logic, which may include hardware, firmware, software, or any combination thereof. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Embodiments of the present techniques use multi-point touch sensing to identify patterns that represent an identifier. Specific patterns may be formed on input devices, objects that are tracked, and so on. The patterns identify the input device to a touch platform without resorting to active devices that are resource-intensive (in terms of cost, power, and bandwidth). Instead, digitizer pens, stylus, dice, joysticks, controller pads, pawns, and so on may be uniquely identified by a pattern the input device presents as multiple points of a touch on the touch platform.

FIG. 1 is a block diagram of an example computing device 100 for identifying input devices based on multi-point touch entry, in accordance with embodiments. The computing device 100 having a processor 102, a memory 104, a storage device 106 comprising a non-transitory computer-readable medium, connected through a bus 108 that also connects with a network interface card 110 and a touchscreen 116. The NIC 110 may provide access to various networks, including local area networks, wide area networks, collections of networks, and so on. In one embodiment, the NIC 110 provides access to the Internet.

One or more input devices 118 are used to interact with the device 100 through the touch screen 116. The input device 118 includes a pattern 120 that uniquely identifies the input device 118 to the computing device 100. A detection manager 112 in the memory 104 uses learned patterns 114 to uniquely identify the pattern 120 on an input device 118. The detection manager 112 may be logic, such as, hardware logic. In some embodiments, the detection manager 112 is a set of instructions in memory 104 that, when executed, direct the processor 102 to perform operations including identifying a plurality of points of a touch on the touchscreen 116. A plurality of locations of the touch are identified. The pattern 120 is identified based on the points of the touch and the locations of the touch. The input device 118 is identified based on the pattern 120. The pattern 120 is formed on an object tracked by an application being executed by the computing device. The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU). The memory 104 can include random access memory (RAM) (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems. The main processor 102 may be connected through a system bus 108 (e.g., Peripheral Component Interconnect (PCI), Industry Standard Architecture (ISA), PCI-Express, HyperTransport®, NuBus, etc.) to components including the memory 104, the storage device 106, ports 110, NIC 110, and touch screen 116. The block diagram of FIG. 1 is not intended to indicate that the computing device 100 is to include all of the components shown in FIG. 1. Further, the computing device 100 may include any number of additional components not shown in FIG. 1, depending on the details of the specific implementation.

In one embodiment, touch controller firmware or logic, identifies the location of the touch, and identifies the pattern of the touch points. If the pattern 120 matches one of the learned patterns 114, a match signal may be broadcast. Additionally, the location of the input device 118 presenting the specific pattern 120 is noted. By extending existing firmware and software, the pattern recognition can be exposed to higher layers of software which can track the pattern (and hence, the movement of the input device 118) across the screen.

Advantageously, embodiments of the present techniques may be implemented without changes to existing touch hardware. For example, in the example of a stylus input device, the tip of the stylus includes a patterned tip. A firmware change to existing technology may enable the tracking feature of such a stylus. Additionally, applications can track passive input devices 118 without additional hardware cost, or power constraint. Also, manufacturers may use the present techniques to create a set of unique and useful accessories, i.e., input devices 118. The accessories may include wearable computing devices, such as a digital glove.

In another embodiment, the pattern 120 for an input device is dynamic. For example, by adding circuitry behind the patterns of an input device 118, a serial communication can be initiated between the computing device 100 and the input device 118. The patterns 120 presented by the device 118 on the touch screen 116 may be generated dynamically to perform the serial communication.

In some embodiments, the touch screen 116 is a capacitive touch screen. The capacitive touch screen works based on the amount of interaction between a capacitor (formed internal to the touch screen) and an external grounded object, e.g., a human hand. A touch controller (not shown) scans the touch screen's hundreds of capacitors and checks for a change in capacitance. At the area where the human finger is touching, the capacitance of the local capacitors changes—which is identified by the touch controller. Multi point touch controllers can track multiple finger touches. Similarly, palm rejection is a feature in software where the area formed by the palm resting on the screen is marked in software, and any touch within this area is rejected.

In some embodiments, the touch screen 116 incorporates existing multi-point touch sensing, or mutual capacitance based projected touch, where multiple points of touch are identified. This capability can be extended to identify patterns 120 formed on objects, such as the input device 118, which are identified or tracked, such as, digitizer pens, stylus, electronic accessories like dice, joysticks, controller pads, pawns, etc. Additionally, touch controller firmware, apart from identifying the location of the touch, also identifies the pattern 120 of the touch points.

Advantageously, embodiments of the present techniques provide useful functionality without making cost a limiting factor. Additionally, traceability is added to standard passive objects, such as a stylus or wearable device. In this way, multiple uniquely-traceable passive input devices may be used without changes to infrastructure that supports specific input devices 118. Another advantage arises from the abilities to detect raw touch inputs from a touch sensor integrated circuit, and process and check for patterns 114 within fast local circuitry, such as a processor cache, graphics processor, graphics cache, and the like.

FIG. 2 is a process flow diagram of a method 200 for sensing and assisting computing device connections, in accordance with embodiments. The method 200 is performed by the detection manager 112, and begins at block 202, where the detection manager 112 identifies multiple points of touch on the touch screen. The touch is associated with an input device 118. At block 204, the detection manager 112 identifies a pattern based on the touch. In one embodiment, the detection manager compares the pattern 120 formed by the touch to learned patterns 114, looking for a match. At block 206, the detection manager 112 identifies the input device 118 based on the pattern 120.

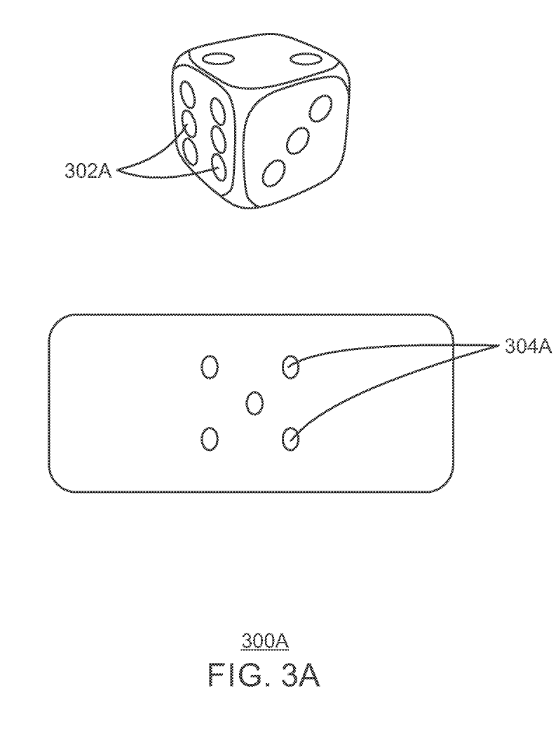

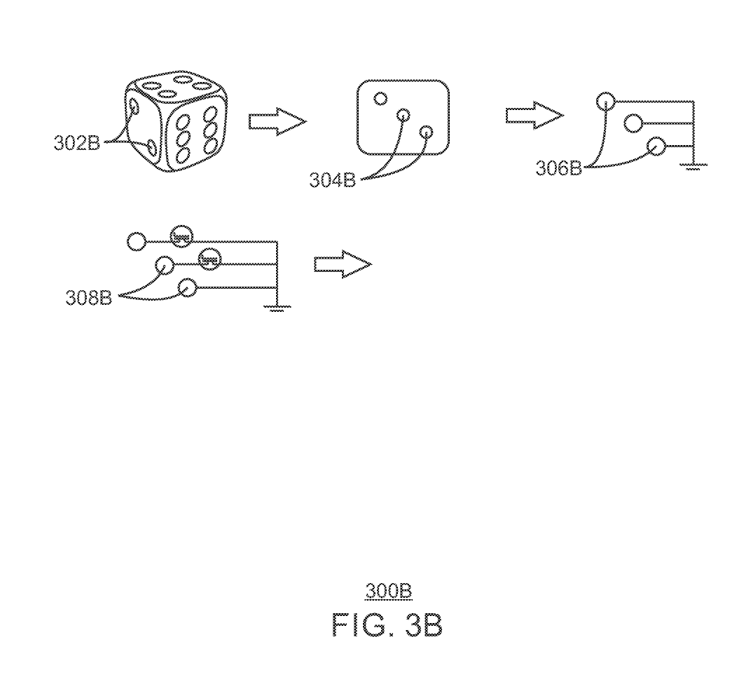

FIGS. 3A-3B are block diagrams 300A, 300B of example input devices 302A, 302B for multi-point touch identification, in accordance with embodiments. The input devices 302A, 302B are electronic dice that may be rolled on the touch screen surface. When a particular face 304A of the die, “5,” falls on the capacitive touch screen, a unique pattern is created. The pattern is created by the number of conductive pads on the face of the dice. The number of dots corresponds to the face 304A touching the touch screen 116. Software may look at the pattern of dots formed on the touch screen 116, and the opposite face of the dice can be deduced.

In one embodiment, the die 302B is an electronic die that presents a serial stream through the pattern of the face 304B. When the serial stream is presented to the gates of the field-effect transistors of the touch screen, the pattern 308B of grounding points on the touch screen 116 varies. For example, a bi-phase coded serial stream may be used. Differential patterns, such as in universal serial bus—DP/DN ensure robust communication to the device 100. The pattern 308B can be identified by touch firmware, and by following standard serial communication protocol, such as preamble, clock recovery and data capture. In this way, a seemingly passive device can communicate to the computing device 100 through the touch surface 116 without wires, and without the use of power hungry (and expensive) wireless technology. This advantageously results in reduced battery usage over active input devices, as there is no power used for wireless, no wires and ultra cool ID. In another embodiment, the input device 118 is wearable.

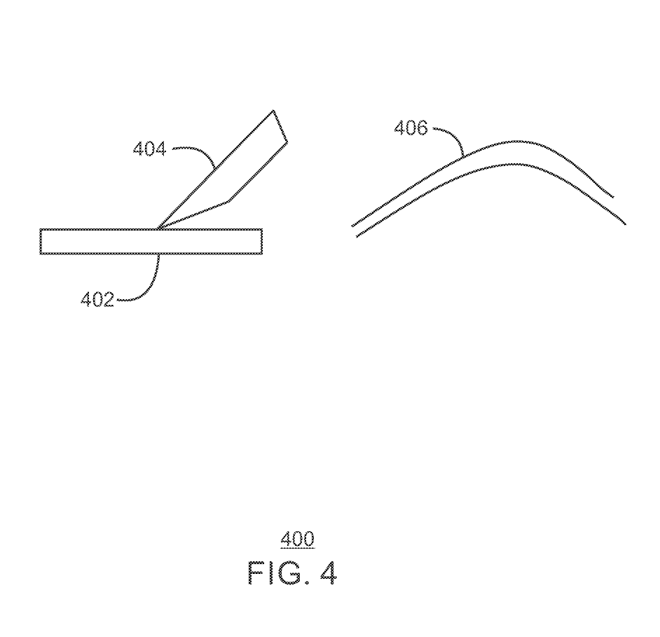

FIG. 4 is a block diagram 400 of an example input device 404 for multi-point touch identification, in accordance with embodiments. The input device 404 is a stylus that traces a specific pattern 406 across the touch surface 402.

The present techniques include several examples of input devices 118, such as uniquely traceable passive styli. Currently, only active styli carry ID which can be tracked. However, embodiments of the present techniques may be employed in low cost passive styli. Additionally, input devices 118 are not limited to stylus, and include a range of intelligent accessories that may be passive or active. Another example of passive styli is a set of 32 chess pieces for a chess game played on the device 100. Each chess piece has a unique pattern on its base, identifying the type of piece, which team the piece belongs to, and so on. In such an embodiment, when a virtual chess board is formed on a tablet or table top, the touch firmware tracks the location of each chess piece without user intervention.

Additional embodiments of input devices 118 include include wearables, such as a personal health monitor. Over the period of a day, the monitor tracks user health data, and at the end of the day, the monitor transfers data back to the cloud through a touch screen device 100. To enable this data dump, active pattern based communication can enable data to be securely transferred with low power and cost.

The serial communication protocol may be limited by the number of unique touch points and the report rate supported by the touch integrated circuit. For example, a touch controller supporting 20 touch points at 200 Hz can theoretically support a data rate of 4 Kbps in single ended mode and 2 Kbps in differential mode. The max number of touches is dependent on the touch processor. However, touch processing may be internal, which enables extending the report rate and touch points in a useful manner. With higher touch points and report rate, very high data transmission speeds can be increased, similar to established wireless protocols.

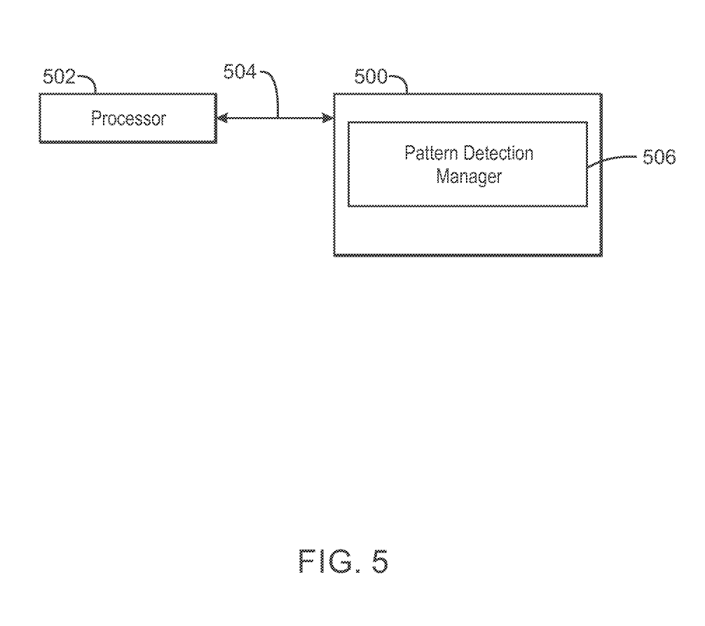

FIG. 5 is a block diagram depicting an example of a tangible, non-transitory computer-readable medium 500 for multi-point touch identification, in accordance with embodiments. The tangible, non-transitory, computer-readable medium 500 may be accessed by a processor 502 over a computer bus 504. Furthermore, the tangible, non-transitory, computer-readable medium 500 may include computer-executable instructions to direct the processor 502 to perform the steps of the current method. The various software components discussed herein may be stored on the tangible, non-transitory, computer-readable medium 500, as indicated in FIG. 5.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system, comprising:
multi-point touch sensor firmware that:
identifies multiple points of touch;
identifies a pattern based on the multiple points of touch; and
identifies an input device to the system based on the pattern.

2. The system of claim 1 the pattern being formed on an object that is tracked by an application of the system.

3. The system of claim 1, the multi-point touch sensor firmware identifying a plurality of locations of the touch.

4. The system of claim 1, the multi-point touch sensor firmware broadcasting a match signal if the pattern matches a learned pattern.

5. The system of claim 1, the multi-point touch sensor firmware conducting serial communication with the input device.

6. The system of claim 5, the input device alternating the patterns presented for the multi-touch point sensor firmware.

7. The system of claim 6, the input device comprising circuitry that enables alternating the patterns.

8. The system of claim 7, the input device comprising a personal health assistant.

9. The system of claim 1, the input device comprising a die comprising grounded contacts representing dots of the die.

10. The system of claim 1, the input device comprising a plurality of input devices.

11. The system of claim 1, the input devices comprising a set of chess pieces for a game of chess played on a surface of the system, the game being associated with an application running on the system.

12. A method of using multi-point touch for identification, the method comprising:
identifying a plurality of points of a touch on a touchscreen;
identifying a plurality of locations of the touch;
identifying a pattern based on the points of the touch and the locations of the touch; and
identifying an input device based on the pattern, the pattern being formed on an object tracked by an application, the application being executed by a computing device comprising the touchscreen.

13. The method of claim 12, comprising broadcasting a match signal if the pattern matches a learned pattern.

14. The method of claim 12, comprising conducting serial communication between the input device and the computing device.

15. The method of claim 14, comprising the input device alternating a plurality of patterns presented.

16. The method of claim 15, the input device comprising circuitry that enables alternating the patterns.

17. The method of claim 16, the input device comprising a stylus.

18. A non-transitory computer readable medium including code, when executed, to cause a processing device to:
identify a plurality of points of a touch on a touchscreen;
identify a plurality of locations of the touch;
identify a pattern based on the points of the touch and the locations of the touch; and
identify an input device based on the pattern, the pattern being formed on an object tracked by an application, the application being executed by a computing device comprising the touchscreen;
and conducting serial communication between the input device and the computing device based on a plurality of patterns presented by the input device.

19. The media of claim 18, the input device comprising a plurality of input devices.

20. The media of claim 18, comprising broadcasting a match signal if the pattern matches a learned pattern.

21. A system, comprising:
multi-point touch sensor logic to:
identify multiple points of touch;
identify a pattern based on the multiple points of touch; and
identify an input device to the system based on the pattern.

22. The system of claim 21 the pattern being formed on an object that is tracked by an application of the system.

23. The system of claim 21, wherein the multi-point touch sensor logic is to identify a plurality of locations of the touch.

24. The system of claim 21, wherein the multi-point touch sensor logic is to broadcast a match signal if the pattern matches a learned pattern.

25. The system of claim 21, wherein the multi-point touch sensor logic is to conduct serial communication with the input device.
